(19) United States
(12) Patent Application Publication
(10) Pub. No.: US 2026/0164127 A1
(43) Pub. Date: Jun. 11, 2026

(54) IMAGE SENSOR, ELECTRONIC APPARATUS INCLUDING THE SAME, AND METHOD OF PERFORMING AUTOFOCUS

(71) Applicant: SAMSUNG ELECTRONICS CO., LTD., Suwon-si (KR)

(72) Inventors: Soongeun JANG, Suwon-si (KR); Sookyoung ROH, Suwon-si (KR); Junho LEE, Suwon-si (KR)

(73) Assignee: SAMSUNG ELECTRONICS CO., LTD., Suwon-si (KR)

(21) Appl. No.: 19/181,974

(22) Filed: Apr. 17, 2025

(30) Foreign Application Priority Data
Aug. 9, 2024 (KR) 10-2024-0107165

(51) Int. Cl. H04N 23/67; G02B 27/10; G02B 27/12; H04N 23/12; H04N 25/702; H04N 25/704; H04N 25/705

(52) U.S. Cl. CPC H04N 23/672; G02B 27/1013; G02B 27/123; H04N 23/12; H04N 23/675; H04N 25/702; H04N 25/704; H04N 25/705

(57) ABSTRACT

An image sensor, including: a sensor substrate including a first unit pixel, a second unit pixel, a third unit pixel, and a fourth unit pixel; a color separation lens array above the sensor substrate, and including a plurality of nanoposts configured to separate and condense incident light onto a corresponding pixel; and an optical diffuser, wherein each unit pixel includes a first pixel configured to sense light having a first wavelength, a second pixel configured to sense light having a second wavelength, and a third and fourth pixel configured to sense light having a third wavelength, wherein the first unit pixel is arranged according to a first structure, and the second unit pixel, the third unit pixel, and the fourth unit pixel are arranged according to at least one different structure which is rotated or flipped with respect to the first structure.

### CROSS-REFERENCE TO RELATED APPLICATION

This application is based on and claims priority under 35 U.S.C. § 119 to Korean Patent Application No. 10-2024-0107165, filed on Aug. 9, 2024, in the Korean Intellectual Property Office, the disclosure of which is incorporated by reference herein in its entirety.

### BACKGROUND

### 1. Field

The disclosure relates to an image sensor, an electronic apparatus including the same, and a method of performing autofocus. More specifically, the disclosure relates to a meta-pixel structure image sensor including a pixel array of a rotating structure or a flip structure, an electronic apparatus including the same, and an autofocusing method performed by the electronic apparatus.

### 2. Description of the Related Art

As the number of pixels included in image sensors increases, it may be desirable to use pixel miniaturization. Securing the quantity of light and removing noise are important issues for pixel miniaturization.

Image sensors may capture images having various colors or detect the color of incident light using a color filter. However, because the color filter may absorb light of the remaining colors in addition to light of color corresponding to the color filter, the light utilization efficiency of color filters may be reduced. For example, in the case of a red-green-blue (RGB) color filter, only one-third of the incident light may be transmitted, and the remaining two-thirds of the incident light may be absorbed. Accordingly, the light utilization efficiency of the color filter may only be about 33%, which means that light loss may be relatively high.

Some approaches to improving the light utilization efficiency of an image sensor may include the use of a color separation lens array. The color separation lens array may separate the color of the incident light using diffraction or refraction characteristics of incident light depending on the wavelength, and adjust the directionality for each wavelength according to the refractive index and shape. In the case of an image sensor having a meta-pixel structure, the color of incident light may be separated within a unit pixel by a color separation lens array, and the color separated light may be transmitted to each corresponding pixel.

### SUMMARY

Provided is an image sensor having a meta pixel structure capable of performing an autofocus function and including a pixel arrangement of a rotating structure or a flip structure.

Also provided is an electronic apparatus including a meta pixel structure image sensor capable of performing an autofocus function by including a pixel arrangement of a rotating structure or a flip structure.

Also provided is an autofocusing method performed by an image sensor having a meta pixel structure including a pixel arrangement having a rotating structure or a flip structure, and an electronic apparatus including the image sensor.

Additional aspects will be set forth in part in the description which follows and, in part, will be apparent from the description, or may be learned by practice of the presented embodiments of the disclosure.

In accordance with an aspect of the disclosure, an image sensor includes: a sensor substrate having a plurality of unit patterns, wherein each unit pattern from among the plurality of unit patterns includes a plurality of unit pixels, and wherein the plurality of unit pixels includes a first unit pixel, a second unit pixel, a third unit pixel, and a fourth unit pixel; a color separation lens array above the sensor substrate, and including a plurality of nanoposts, wherein the plurality of nanoposts are configured to separate incident light according to a wavelength within each unit pixel, and condense the separated light onto a corresponding pixel; and an optical diffuser on the color separation lens array, wherein each unit pixel from among the plurality of unit pixels includes at least one first pixel configured to sense light having a first wavelength, at least one second pixel configured to sense light having a second wavelength, and at least one third pixel and at least one fourth pixel configured to sense light having a third wavelength, wherein the first unit pixel is arranged according to a first structure, and wherein the second unit pixel, the third unit pixel, and the fourth unit pixel are arranged according to at least one different structure which is rotated or flipped with respect to the first structure.

The image sensor may be configured to perform an autofocus function using a plurality of images having different disparities which are acquired from first pixels at different positions within the plurality of unit pixels.

The plurality of unit pixels may be arranged in 2×2 array in each unit pattern, the first unit pixel may be included in a first row and a first column of each unit pattern, the second unit pixel may be included in a second row and the first column of each unit pattern, the third unit pixel may be included in the first row and a second column of each unit pattern, and the fourth unit pixel may be included in the second row and the second column of each unit pattern.

The second unit pixel may be arranged according to a second structure which is rotated by 90 degrees in a clockwise direction with respect to the first structure, the third unit pixel may be arranged according to a third structure which is rotated by 270 degrees in the clockwise direction with respect to the first structure, and the fourth unit pixel may be arranged according to a fourth structure which is rotated by 180 degrees with respect to the first structure.

The second unit pixel may be arranged according to a second structure which is rotated by 90 degrees in a counterclockwise direction with respect to the first structure, the third unit pixel may be arranged according to a third structure which is rotated by 270 degrees in the counterclockwise direction with respect to the first structure, and the fourth unit pixel may be arranged according to a fourth structure which is rotated by 180 degrees with respect to the first structure.

The second unit pixel may be arranged according to a second structure in which a first row and a second row are flipped with respect to the first structure, the third unit pixel may be arranged according to a third structure in which a first column and a second column are flipped with respect to the first structure, and the fourth unit pixel may be arranged according to a fourth structure which is flipped in a diagonal direction with respect to the first structure.

A width of each of the first to fourth pixels may be in a range of 0.5 micrometers (μm) to 0.64 μm.

In accordance with an aspect of the disclosure, an electronic apparatus includes: a lens assembly including one or more lenses, wherein the lens assembly is configured to form an optical image of a subject; an image sensor configured to convert the optical image into an electrical signal; and a processor configured to process the electrical signal, wherein the image sensor includes: a sensor substrate having a plurality of unit patterns, wherein each unit pattern from among the plurality of unit patterns includes a plurality of unit pixels, and wherein the plurality of unit pixels includes a first unit pixel, a second unit pixel, a third unit pixel, and a fourth unit pixel; a color separation lens array above the sensor substrate and including a plurality of nanoposts, wherein the plurality of nanoposts are configured to separate incident light according to a wavelength within each unit pixel and condense the separated light onto a corresponding pixel; and an optical diffuser on the color separation lens array, and wherein each unit pixel from among the plurality of unit pixels includes at least one first pixel configured to sense light having a first wavelength, at least one second pixel configured to sense light having a second wavelength, and at least one third pixel and at least one fourth pixel configured to sense light having a third wavelength, wherein the first unit pixel is arranged according to a first structure, and wherein the second unit pixel, the third unit pixel, and the fourth unit pixel are arranged according to at least one different structure which is rotated or flipped with respect to the first structure.

An autofocus function may be performed using a plurality of images having different disparities which are acquired from first pixels at different positions within the plurality of unit pixels.

In accordance with an aspect of the disclosure, an autofocusing method includes: selecting an autofocus position; acquiring an image of a selected area using a plurality of pixels at different positions within a plurality of unit pixels, wherein the plurality of unit pixels are included in a unit pattern and include a first unit pixel, a second unit pixel, a third unit pixel, and a fourth unit pixel; measuring a disparity between a plurality of images of the selected area which are acquired from the plurality of pixels provided at the different positions; determining a distance between a subject and an image sensor based on the disparity; and adjusting a focus lens based on the distance, wherein the first unit pixel is arranged according to a first structure, and wherein the second unit pixel, the third unit pixel, and the fourth unit pixel are arranged according to at least one different structure which is rotated or flipped with respect to the first structure.

The measuring of the disparity between the plurality of images may include: acquiring a first image using a first pixel included in the first unit pixel; acquiring a second image using a first pixel included in the second unit pixel; and measuring a disparity between the first image and the second image.

The measuring of the disparity between the plurality of images may include: acquiring a first image using a first pixel included in the first unit pixel; acquiring a second image using a first pixel included in the second unit pixel; acquiring a third image using a first pixel included in the third unit pixel; measuring a first disparity based on the first image and the second image; and measuring a second disparity based on the first image and the third image.

The autofocusing method may further include selecting one from among the first disparity and the second disparity by comparing the first disparity and the second disparity with a plurality of disparities included in a pre-stored table.

The second unit pixel may be arranged according to a second structure which is rotated by 90 degrees in a clockwise direction with respect to the first structure, the third unit pixel may be arranged according to a third structure which the first unit pixel is rotated by 270 degrees in the clockwise direction with respect to the first structure, and the fourth unit pixel may be arranged according to a fourth structure which is rotated by 180 degrees with respect to the first structure.

The second unit pixel may be arranged according to a second structure which is rotated by 90 degrees in a counterclockwise direction with respect to the first structure, the third unit pixel may be arranged according to a third structure which is rotated by 270 degrees in the counterclockwise direction with respect to the first structure, and the fourth unit pixel may be arranged according to a fourth structure which is rotated by 180 degrees with respect to the first structure.

The second unit pixel may be arranged according to a second structure in which a first row and second row are flipped with respect to the first structure, the third unit pixel may be arranged according to a third structure in which a first column and a second column are flipped with respect to the first structure, and the fourth unit pixel may be arranged according to a fourth structure in which the first unit pixel is flipped based on a diagonal direction with respect to the first structure.

In accordance with an aspect of the disclosure, an image sensor includes: a sensor substrate including a plurality of unit pixels; a color separation lens array above the sensor substrate, and including a plurality of nanoposts, wherein the plurality of nanoposts are configured to separate incident light according to a wavelength within each unit pixel of the plurality of unit pixels, and condense the separated light onto a corresponding pixel; and an optical diffuser on the color separation lens array, wherein each unit pixel from among the plurality of unit pixels includes a plurality of pixels including a first pixel configured to sense light having a first wavelength, a second pixel configured to sense light having a second wavelength, and a third pixel a fourth pixel configured to sense light having a third wavelength, and wherein the plurality of unit pixels includes: a first unit pixel in which the plurality of pixels are arranged according to first pattern, and a plurality of other unit pixels in which the plurality of pixels are arranged in at least one other pattern that is rotated or flipped with respect to the first pattern.

The image sensor may further include an image signal processor configured to perform an autofocus function using a plurality of images which are acquired from pixels corresponding to a same color at different positions within the plurality of unit pixels.

The image signal processor may be further configured to perform the autofocus function by calculating disparities between the plurality of images.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram schematically showing an overall structure of an image sensor according to an embodiment;

FIG. 2 is a schematic plan view of a pixel array of an image sensor according to an embodiment;

FIG. 3 is a cross-sectional view taken along a line I-I′ of FIG. 2;

FIG. 4 is a cross-sectional view taken along a line II-II′ of FIG. 2;

FIG. 5 is a perspective view schematically illustrating some components of a pixel array of an image sensor according to an embodiment of FIG. 2;

FIG. 6 is a schematic plan view of a pixel array of an image sensor according to another embodiment;

FIG. 7 is a schematic plan view of a pixel array of an image sensor according to another embodiment;

FIGS. 8 and 9 are views respectively illustrating a disparity occurring due to a phase difference for each color of each pixel of an image sensor and a view angle relationship for each pixel due to the disparity according to an embodiment;

FIG. 10 is a flowchart illustrating a method of performing an autofocus function according to an embodiment;

FIG. 11 is a flowchart illustrating acquiring an inter-image disparity of FIG. 10 according to an embodiment;

FIG. 12 is a block diagram schematically illustrating an electronic apparatus including an image sensor according to an embodiment;

FIG. 13 is a block diagram schematically illustrating a camera module of FIG. 12;

FIG. 14 is a block diagram of an electronic apparatus including a multi-camera module; and

FIG. 15 is a detailed block diagram of the multi-camera module of the electronic apparatus illustrated in FIG. 14.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, an image sensor including a color separation lens array and an electronic apparatus including the image sensor are described in detail with reference to the accompanying drawings. Embodiments described below are merely illustrative, and various modifications are possible from these embodiments. In the following drawings, the same reference numerals refer to the same components, and the size of each component in the drawings may be exaggerated for clarity and convenience of description.

Hereinafter, the term “on” may also include “to be present on the top, bottom, left or right portion on a non-contact basis” as well as “to be present just on the top, bottom, left or right portion on a direct contact basis”.

The terms first, second, etc. may be used to describe various components, but are used only for the purpose of distinguishing one component from another component. These terms do not limit the difference in material or structure of components.

Singular expressions include plural expressions unless they are explicitly meant differently in context. In addition, when a part “includes” a component, this means that it may include more other components, rather than excluding other components, unless otherwise stated.

Further, the terms “unit”, “module” or the like may mean a unit that processes at least one function or operation, which may be implemented in hardware or software or implemented in a combination of hardware and software.

The use of the term “the” and similar indicative terms may correspond to both singular and plural. In addition, the use of all illustrative terms (e.g., etc.) is simply intended to detail technical ideas and, unless limited by the claims, the scope of rights is not limited due to the terms.

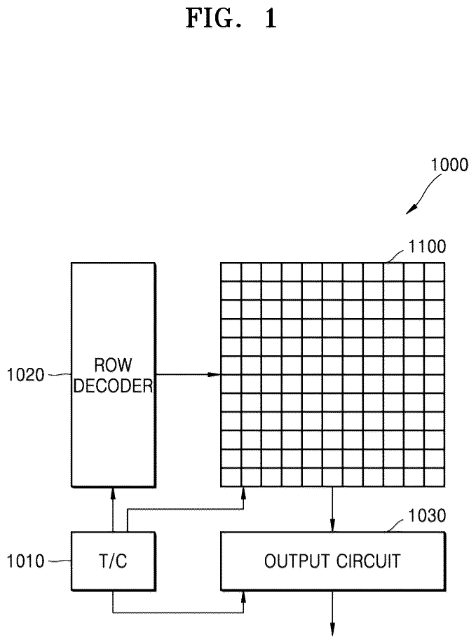

FIG. 1 is a schematic block diagram of an image sensor.

Referring to FIG. 1, an image sensor 1000 may include a pixel array 1100, a timing controller 1010 (illustrated as “T/C”), a row decoder 1020, and an output circuit 1030. The image sensor 1000 may include at least one of a charge coupled device (CCD) image sensor and a complementary metal oxide semiconductor (CMOS) image sensor.

The pixel array 1100 may include pixels arranged two-dimensionally along a plurality of rows and columns. The row decoder 1020 may select one of the rows of the pixel array 1100 in response to a row address signal output from the timing controller 1010. The output circuit 1030 may output a light detection signal in units of columns from a plurality of pixels arranged along the selected row. In order to do so, the output circuit 1030 may include a column decoder and an analog-to-digital converter (ADC). For example, the output circuit 1030 may include a plurality of analog-to-digital converters (ADCs) provided for each column between a column decoder and the pixel array 1100, or one ADC provided at the output end of the column decoder. The timing controller 1010, the row decoder 1020, and the output circuit 1030 may be implemented as one chip or separate chips. A processor for processing an image signal output through the output circuit 1030 may be implemented as one chip together with the timing controller 1010, the row decoder 1020, and the output circuit 1030.

The pixel array 1100 may include a plurality of pixels configured to sense light having different wavelengths. The pixel arrangement of the pixel array 1100 may be implemented in various ways, and for example, the pixel array 1100 may have a pixel arrangement according to examples described in greater detail below.

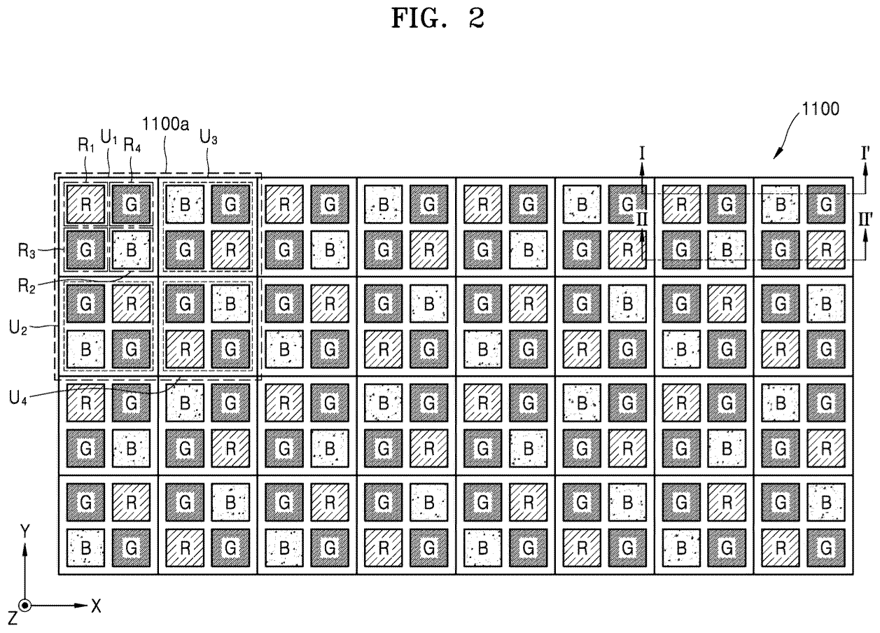

FIG. 2 is a schematic plan view of a pixel array of an image sensor according to an embodiment.

Referring to FIG. 2, a unit pattern 1100a includes four unit pixels, for example a first unit pixel U₁, a second unit pixel U₂, a third unit pixel U₃, and a fourth unit pixel U₄. Each of the unit pixels U₁, U₂, U₃, and U₄ includes four quadrant regions, for example a first quadrant region R₁, a second quadrant region R₂, a third quadrant region R₃, and a fourth quadrant region R₄. As shown in FIG. 2, one unit pattern (e.g., the unit pattern 1100a) may include a 2×2 arrangement of unit pixels (e.g., the first to fourth unit pixels U₁, U₂, U₃, and U₄), and each of the unit pixels may include a 2×2 arrangement of quadrant regions (e.g., the first to fourth quadrant regions R₁, R₂, R₃, and R₄).

For example, the first unit pixel U₁ may be located in a first row and a first column in the unit pattern 1100a, the second unit pixel U₂ may be located in a second row and the first column in the unit pattern 1100a, the third unit pixel U₃ may be located in the first row and a second column in the unit pattern 1100a, and the fourth unit pixel U₄ may be located in the second row and the second column in the unit pattern 1100a.

In addition, the first quadrant region R₁ may be located in a first row and a first column within each of the first to fourth unit pixels U₁, U₂, U₃, and U₄, the second quadrant region R₂ may be located in a second row and a second column within each of the first to fourth unit pixels U₁, U₂, U₃, and U₄, the third quadrant region R₃ may be located in the second row and the first column within each of the first to fourth unit pixels U₁, U₂, U₃, and U₄, and the fourth quadrant region R₄ may be located in the first row and the second column within each of the first to fourth unit pixels U₁, U₂, U₃, and U₄. A pixel may be provided in each of the first to fourth quadrant regions R₁, R₂, R₃, and R₄. For example, a first pixel configured to sense light having a first wavelength may be provided in the first quadrant region R₁ (e.g., the first row and the first column) of the first unit pixel U₁, a second pixel configured to sense light having a second wavelength may be provided in the second quadrant region R₂ (e.g., the second row and the second column) of the first unit pixel U₁, a third pixel configured to sense light having a third wavelength may be provided in the third quadrant region R3 (e.g., the second row and the first column) of the first unit pixel U₁, and a fourth pixel configured to sense light having a third wavelength may be provided in the fourth quadrant region R₄ (e.g., the first row and the second column) of the first unit pixel U₁. A width of each pixel may be in a range of approximately 0.5 μm to approximately 0.64 μm, but embodiments are not limited thereto. The first pixel may be a red pixel R, the second pixel may be a blue pixel B, the third pixel may be a green pixel G, and the fourth pixel may be a green pixel G. however, this is only an example, and the first to fourth quadrant regions R₁, R₂, R₃, and R₄ may be a red pixel R, a green pixel G, a blue pixel B, and a blue pixel B, respectively. Hereinafter, for convenience of description, a case in which the first pixel is a red pixel R, the second pixel is a blue pixel B, the third pixel is a green pixel G, and the fourth pixel is a green pixel G is described as an example.

The second to fourth unit pixels U₂, U₃, and U₄ may have a structure that is similar to a structure of the first unit pixel U₁, but is rotated. For example, the first unit pixel U₁ may be arranged according to a first structure, the second unit pixel U₂ may be arranged according to a second structure that is rotated by 90 degrees in a clockwise direction with respect to the first structure, the third unit pixel U₃ may be arranged according to a third structure that is rotated by 180 degrees in the clockwise direction with respect to the first structure, and the fourth unit pixel U₄ may be arranged according to a fourth structure in which the first unit pixel U₁ is rotated by 270 degrees in the clockwise direction with respect to the first structure.

For example, in the second unit pixel U₂, the 2×2 arrangement of the first unit pixel U₁ may be rotated 90 degrees in the clockwise direction so that the red pixel R is provided in the first row and the second column of the second unit pixel U₂, the blue pixel B is provided in the second row and the first column of the second unit pixel U₂, one green pixel G is provided in the first row and the first column of the second unit pixel U₂, and the another green pixel G is provided in the second row and the second column of the second unit pixel U₂. In the third unit pixel U₃, the 2×2 arrangement of the first unit pixel U₁ may be rotated 180 degrees in the clockwise direction so that the red pixel R is provided in the second row and the second column of the third unit pixel U₃, the blue pixel B is provided in the first row and the first column of the third unit pixel U one green pixel G is provided in the first row and the second column of the third unit pixel U₃, and another green pixel G is provided in the second row and the first column of the third unit pixel U₃. In the fourth unit pixel U₄, the 2×2 arrangement of the first unit pixel U₁ may be rotated 270 degrees in the clockwise direction so that the red pixel R is provided in the second row and the first column of the fourth unit pixel U₄, the blue pixel B is provided in the first row and the second column of the fourth unit pixel U₄, one green pixel G is provided in the second row and the second column of the fourth unit pixel U₄, and another pixel G is provided in the first row and the first column of the fourth unit pixel U₄. However, this is merely an example, and the second to fourth unit pixels U₂, U₃, and U₄ may have structures in which the first unit pixel U₁ is rotated at different angles by nπ/2 (where n=1, 2, or 3).

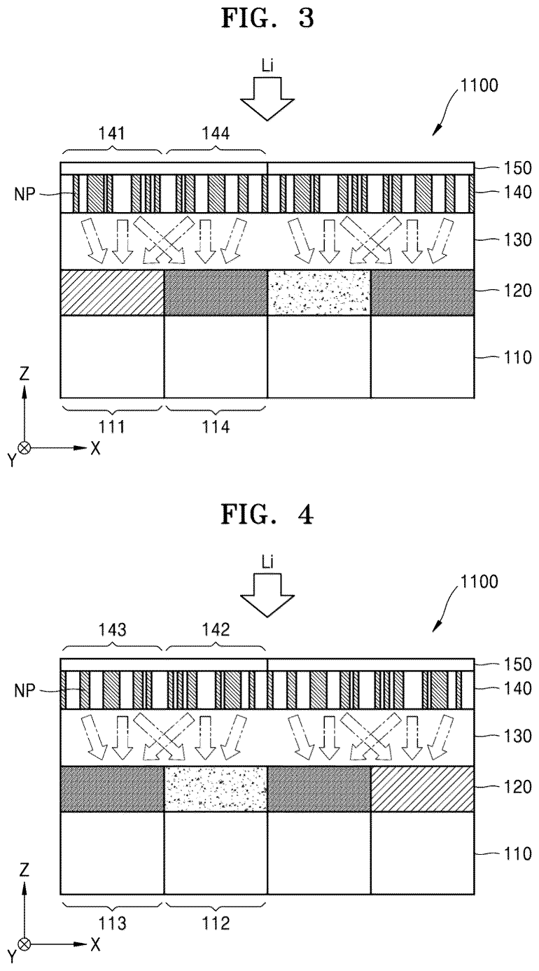

As shown for example in FIG. 3, in the overall pixel arrangement, one unit pattern 1100 a may have a pixel arrangement according to a 4×4 arrangement, and the unit pattern 1100a may be repeatedly arranged in two dimensions in a first direction (e.g., an X direction) and a second direction (e.g., a Y direction).

Therefore, pixels corresponding to each color in one unit pattern 1100a may be provided at different relative positions within the first to fourth unit pixels U₁, U₂, U₃, and U₄ according to the pixel arrangement having such a rotation structure. For example, referring to FIG. 2, the first pixel (e.g., the red pixel R) may be provided in the first row and the first column in the first unit pixel U₁, the first row and the second column in the second unit pixel U₂, the second row and the second column in the third unit pixel U₃ and the second row and the first column in the fourth unit pixel U₄. In addition, the second pixel (e.g., the blue pixel B) may be provided in the second row and the second column in the first unit pixel U₁, the second row and the first column in the second unit pixel U₂, the first row and the first column in the third unit pixel U₃, and the first row and the second column in the fourth unit pixel U₄. In addition, the third pixel (e.g., one green pixel G) may be provided in the second row and the first column in the first unit pixel U₁, the first row and the first column in the second unit pixel U₂, the first row and the second column in the third unit pixel U₃ and the second row and the second column in the fourth unit pixel U₄. In addition, the fourth pixel (e.g., another green pixel G) may be provided in the first row and the second column in the first unit pixel U₁, the second row and the second column in the second unit pixel U₂, the second row and the first column in the third unit pixel U₃ and the first row and the first column in the fourth unit pixel U₄.

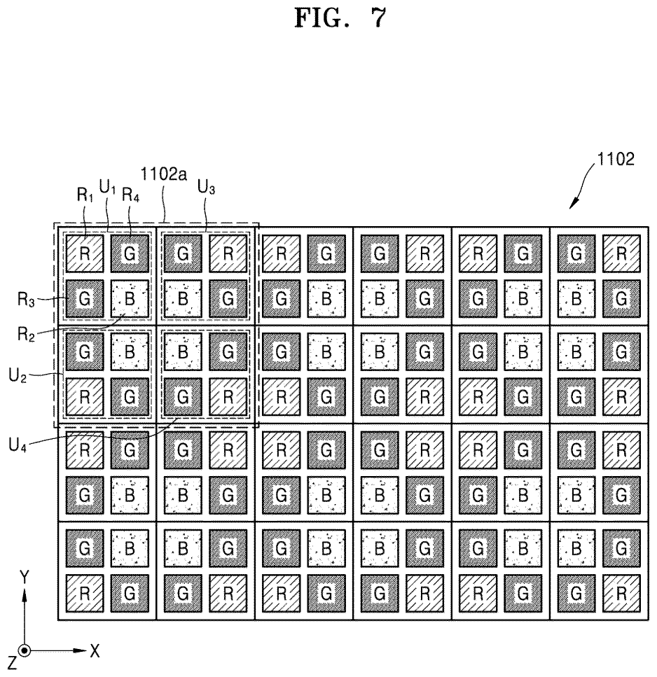

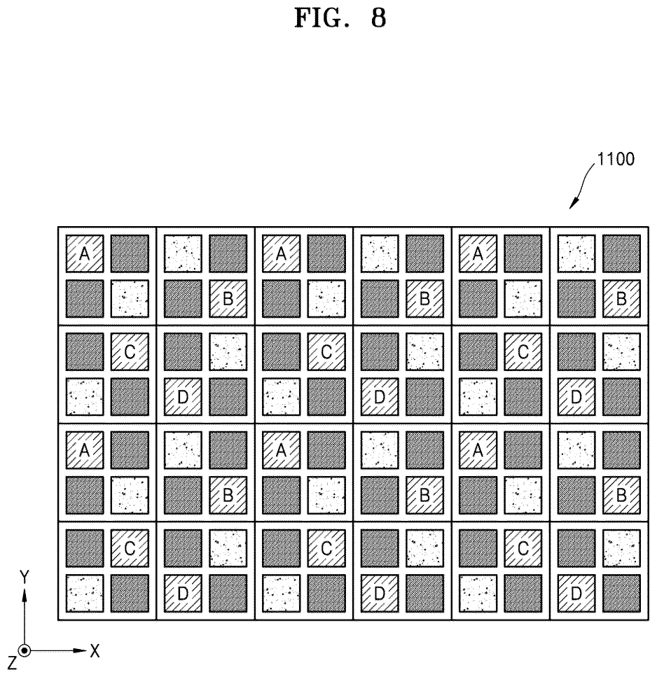

Hereinafter, for conveniences of description, examples in which the pixel array 1100 has a pattern structure as shown in FIG. 2 is described with reference to FIGS. 3 to 5 for convenience, but embodiments are not limited to the following description and may also be applied to pixel arrays 1101 and 1102 having various pattern structures such as a pattern structure as shown in FIGS. 6 to 7.

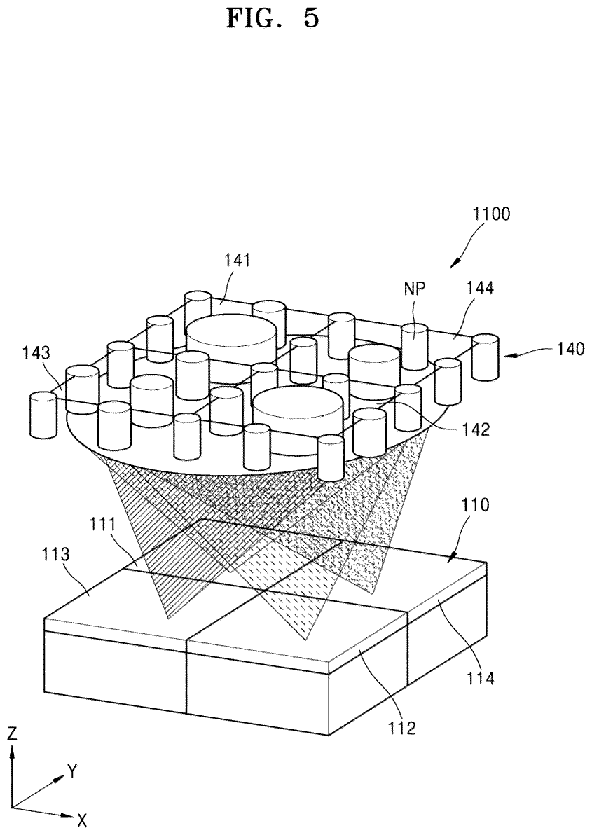

FIGS. 3 and 4 are cross-sectional views schematically illustrating a configuration of a pixel array of an image sensor according to an embodiment. FIG. 3 is a cross-sectional view taken along a line I-I′ of FIG. 2, and FIG. 4 is a cross-sectional view taken along a line II-II′ of FIG. 2.

Referring to FIGS. 3 and 4, the pixel array 1100 may include a sensor substrate 110, a color filter layer 120 provided on the sensor substrate 110, a spacer layer 130 provided on the color filter layer 120, a nano optical lens array 140 provided on the spacer layer 130, and an optical diffuser 150 provided on the nano optical lens array 140.

The sensor substrate 110 may include a plurality of light sensing cells that may be configured convert light into an electrical signal, for example a first light sensing cell 111, a second light sensing cell 112, a third light sensing cell 113, and a fourth light sensing cell 114. The plurality of light sensing cells (e.g., the first to fourth light sensing cells 111, 112, 113, and 114) may be provided in each pixel. This area division may be used to sense incident light by dividing the incident light into unit patterns. For example, the first light sensing cell 111 may be configured to sense light having a first wavelength, the second light sensing cell 112 may be configured to sense light having a second wavelength, and the third light sensing cell 113 and the fourth light sensing cell 114 may be configured to sense light having a third wavelength. The first light sensing cell 111, the second light sensing cell 112, the third light sensing cell 113, and the fourth light sensing cell 114 may be provided in a 2×2 arrangement. The first light sensing cell 111 and the fourth light sensing cell 114 may be arranged in the first direction (e.g., the X direction) with respect to each other, and the first light sensing cell 111 and the third light sensing cell 113 may be arranged in the second direction (e.g., the Y direction) with respect to each other. The first light sensing cell 111 and the second light sensing cell 114 may be arranged in a diagonal direction with respect to each other, and the third light sensing cell 113 and the fourth light sensing cell 114 may be arranged in a diagonal direction with respect to each other.

The spacer layer 130 may be provided between the sensor substrate 110 and the color separation lens array 140 to maintain a constant distance between the sensor substrate 110 and the color separation lens array 140, and may secure a focal length of the color separation lens array 140. The spacer layer 130 may include a material that is transparent to visible light (e.g., light having a wavelength in a range that is visible to a human eye). For example, the spacer layer 130 may include a dielectric material having a refractive index lower than a refractive index of the nanoposts NP of the color separation lens array 140, such as SiO₂, siloxane-based spin on glass (SOG), and the like, and having a low absorption rate in the visible light band.

The color separation lens array 140 may be partitioned in various ways. For example, the color separation lens array 140 may be divided into a first corresponding region 141 that corresponds to the first light sensing cell 111, a second corresponding region 142 that corresponds to the second light sensing cell 112, a third corresponding region 143 that corresponds to the third light sensing cell 113, and a fourth corresponding region 144 that corresponds to the fourth light sensing cell 114. For example, the first corresponding region 141 may correspond to the first light sensing cell 111 and may be provided above the first light sensing cell 111, and the second corresponding region 142 may correspond to the second light sensing cell 112 and may be provided above the second light sensing cell 112. For example, referring to FIGS. 3 and 4, the first to fourth corresponding regions 141, 142, 143, and 144 of the color separation lens array 140 may be provided to face corresponding ones of the first to fourth light sensing cells 111, 112, 113, and 114, respectively. The first corresponding region 141, the second corresponding region 142, the third corresponding region 143, and the fourth corresponding region 144 may be provided diagonally in a 2×2 arrangement in the first direction (e.g., the X direction) and the second direction (e.g., the Y direction). The color separation lens array 140 may include a plurality of nanoposts NP in each of the first to fourth corresponding regions 141, 142, 143, and 144. The nanoposts NP of the color separation lens array 140 may be configured such that color separation occurs in which incident light is separated according to a wavelength only between adjacent pixels. The nanoposts NP of the color separation lens array 140 may be configured such that color separation occurs within the unit pixel arrangement (e.g., a 2×2 arrangement). For example, the color separation lens array 140 may be configured to condense the light having the first wavelength included in the incident light Li incident on the first to fourth corresponding regions 141, 142, 143, and 144, to the first light sensing cell 111, to condense the light having the second wavelength included in the incident light Li incident on the first to fourth corresponding regions 141, 142, 143, and 142, to the second light sensing cell 112, and to condense the light having the third wavelength included in the incident light Li incident on the corresponding regions 141, 142, 143, and 144 to the third light sensing cell 113 or the fourth light sensing cell 114.

The nanoposts NP of the color separation lens array 140 may be configured to perform color separation only within the unit pixel arrangement by forming different phase profiles in the light having the first wavelength, the light having the second wavelength, and the light having the third wavelength, included in the incident light Li. Because the refractive index of the material varies depending on the wavelength of the responding light, the color separation lens array 140 may provide different phase profiles for light having the first wavelength, light having the second wavelength, and light having the third wavelength. For example, because even the same material may have a refractive index which varies depending on the wavelength of light reacting to the material, and also has a phase delay that light experiences when passing through the material which varies from wavelength to wavelength, different phase profiles may be formed for different wavelengths, respectively. For example, the refractive index of the first wavelength light of the first corresponding region 141 and the refractive index of the second wavelength light of the first corresponding region 141 may be different from each other, and the phase delay of the first wavelength light passing through the first corresponding region 141 and the phase delay of the second wavelength light passing through the first corresponding region 141 may be different from each other, and thus, if the color separation lens array 140 is designed in consideration of the characteristics of such light, different phase profiles may be provided for the first to third wavelengths of light. Accordingly, each of the first to fourth corresponding regions 141, 142, 143, and 144 of the color separation lens array 140 may include, for example, a plurality of nanoposts NP in the form of a cylinder.

One or more nanoposts NP may also be provided in each of the first to fourth corresponding regions 141, 142, 143, and 144 of the color separation lens array 140, and the nanoposts NP may have different shapes, dimensions, intervals, and/or arrangements depending on regions. For example, each of the first to fourth corresponding regions 141, 142, 143, and 144 may include one or more nanoposts NP. The dimension, shape, interval, and/or arrangement of the nanoposts NP may be configured such that, among incident light incident on the first to fourth corresponding regions 141, 142, 143, and 144 through the color separation lens array 140, light having the first wavelength is concentrated in the first light sensing cell 111, light having the second wavelength is concentrated in the second light sensing cell 112, and light having the third wavelength is concentrated in the third light sensing cell 113 and the fourth light sensing cell 114.

The nanoposts NP each may have a diameter of a cross-section having a dimension of a sub-wavelength. Here, the sub-wavelength may refer to a wavelength band smaller than a wavelength band of light to be branched. For example, the nanoposts NP may have dimensions less than the first wavelength and the second wavelength for each corresponding region. When the incident light Li is visible light, the diameter of a cross-section of a nanopost NP may have dimensions less than, for example, 400 nm, 300 nm, or 200 nm. Although not shown, the nanoposts NP may be a combination of two or more posts stacked in the height direction (e.g., a Z direction). In addition, the case where the color separation lens array 140 is one layer has been described as an example, but the color separation lens array 140 may have a structure in which multiple layers are stacked.

The nanoposts NP may include a material having a relatively high refractive index compared to a peripheral material and a relatively low absorption rate in a visible light band. For example, the nanoposts NP may include c-Si, p-Si, a-Si, and group III-V compound semiconductors (GaP, GaN, GaAs, etc.), SiC, TiO₂, SiN₃, ZnS, ZnSe, Si₃N₄, and/or combinations thereof. The periphery of the nanoposts NP may be filled with a dielectric material having a relatively low refractive index and a relatively low absorption rate in the visible light band. For example, the periphery of the nanoposts NP may be filled with SiO₂, siloxane-based spin on glass (SOG), air, and the like. The nanoposts NP having a refractive index difference from the surrounding material may change a phase of light passing therethrough. The degree to which the phase is delayed by the color separation lens array 140 may be determined by the specific shape, dimension, and arrangement form of the nanoposts NP.

The optical diffuser 150 may be provided on the color separation lens array 140. The optical diffuser 150 may scatter incident light Li incident in a unit pixel arrangement (e.g., a 2×2 arrangement) and uniformly disperse the incident light Li throughout the first to fourth corresponding regions 141, 142, 143, and 144. The optical diffuser 150 may be divided and provided for every 2×2 arrangement corresponding to the unit pixel arrangement. Most of the incident light Li incident in the unit pixel arrangement may have directionality removed by the optical diffuser 150, and thus may be incident on the color separation lens array 140. Some of the incident light Li incident in the unit pixel arrangement may be incident on the color separation lens array 140 in a state in which directionality is not removed by the optical diffuser 150. Light transmitted through the optical diffuser 150 and incident on the color separation lens array 140 may be color separated within the unit pixel arrangement for each wavelength by the color separation lens array 140, and light color separated by wavelength may be condensed onto the corresponding first to fourth light sensing cells 111, 112, 113, and 114. As described above, a structure in which a color separation of incident light occurs in the unit pixel arrangement and light is condensed to a corresponding pixel of each color may be referred to as a meta pixel structure.

Although the optical diffuser 150 is illustrated as a thin film in FIG. 4, the shape of the optical diffuser 150 is not limited thereto. For example, the optical diffuser 150 may be or may include a structure including one or more pillars, such as the color separation lens array 140, or may be a structure including one or more holes. In addition, the optical diffuser 150 may have a curved shape.

According to embodiments, light incident on the color separation lens array 140 in a state in which directionality has not been removed by the optical diffuser 150, from among the incident light Li, may be color separated within the unit pixel arrangement for each wavelength by the color separation lens array 140. The light color-separated for each wavelength may have a directional orientation that is skewed to a direction from the center of the unit pixel, and may be concentrated by the corresponding first to fourth light sensing cells 111, 112, 113, and 114 to acquire an image having a different disparity for each pixel of each color.

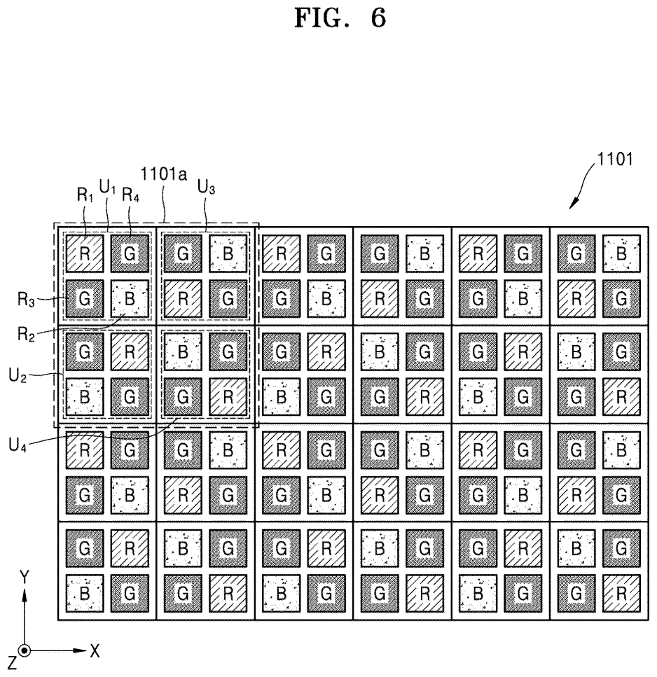

FIG. 5 is a perspective view schematically illustrating some components of a pixel array of an image sensor according to an embodiment of FIG. 2. In FIG. 5, only some components are schematically shown to more clearly express the separation and condensation according to the wavelength of incident light in the color separation lens array 140.

Referring to FIG. 5, the pixel array 1100 of the image sensor 1000 includes a sensor substrate 110 including an array of multiple light sensing cells that sense light, and a color separation lens array 140 arranged on the sensor substrate 110 to separate and condense light according to color in order to be incident to the multiple light sensing cells.

The color separation lens array 140 has a microstructure in each of the first to fourth corresponding regions 141, 142, 143, and 144 facing the first to fourth light sensing cells 111, 112, 113, and 114, and is provided to form a phase profile that condenses light having different wavelengths in adjacent pixels within the unit pixel arrangement, so that incident light may be separated and condensed according to wavelengths. As shown in FIGS. 3 and 4, the microstructure of the color separation lens array 140 may include a plurality of nanoposts NP for forming a phase profile that condenses light having different wavelengths in adjacent light sensing cells within the unit pixel arrangement.

The color separation lens array 140 may include first to fourth corresponding regions 141, 142, 143, and 144 facing the first to fourth light sensing cells 111, 112, 113, and 114 of the sensor substrate 110 in a one-to-one correspondence. For example, the color separation lens array 140 may include first to fourth corresponding regions 141, 142, 143, and 144 facing the first to fourth light sensing cells 111, 112, 113, and 114 of the sensor substrate 110, in a one-to-one correspondence, and the first to fourth corresponding regions 141, 142, 143, and 144 may include nanoposts NP to form a phase profile that condenses light of different wavelengths in adjacent light sensing cells. For example, referring to FIG. 5, the nanoposts NP may be arranged inside the first to fourth corresponding regions 141, 142, 143, and 144 to condense light only inside the first to fourth corresponding regions 141, 142, 143, and 144.

The shapes, dimensions, and arrangements of the first to fourth nanoposts may be determined so that light having a predetermined wavelength passing through the color separation lens array 140 is condensed onto a light sensing cell corresponding to any one of the first to fourth light sensing cells 111, 112, 113, and 114 and forms a phase that does not proceed with the remaining light sensing cells.

For example, the first light sensing cell 111 may sense the light having the first wavelength corresponding to the first pixel, the second light sensing cell 112 may sense the light having the second wavelength corresponding to the second pixel, the third light sensing cell 113 may sense the light having the third wavelength corresponding to the third pixel, and the fourth light sensing cell 114 may sense the light having the third wavelength corresponding to the fourth pixel. However, embodiments are not limited thereto. Although not illustrated at the boundary between cells, a separator for cell separation may be further formed.

FIG. 6 is a schematic plan view of a pixel array of an image sensor according to another embodiment, and FIG. 7 is a schematic plan view of a pixel array of an image sensor according to another embodiment. In FIGS. 6 and 7, each of the first to fourth unit pixels U₁, U₂, U₃, and U₄ of one of unit patterns 1101a and 1102a may include a first pixel (e.g., a red pixel R), a second pixel (e.g., a blue pixel B), a third pixel (e.g., one green pixel G), and a fourth pixel (e.g., another green pixel G). In each of the unit patterns 1101a and 1102a, a first pixel (e.g., a red pixel R) is provided in the first quadrant region R1 (e.g., in the first row and the first column) of the first unit pixel U₁, a second pixel (e.g., a blue pixel B) is provided in the second quadrant region R₂ (e.g., in the second row and the second column) of the first unit pixel U₁, a third pixel (e.g., one green pixel G) is provided in the third quadrant region R₃ (e.g., in the second row and the first column) of the first unit pixel U₁, and a fourth pixel (e.g., another the green pixel G) may be provided in the fourth quadrant region R₄ (e.g., in the first row and the second column) of the first unit pixel U₁. In FIGS. 6 and 7, components using the same reference numerals as shown in FIG. 2 represent the same components, and the difference from FIG. 2 is mainly described.

Referring to FIG. 6, the second to fourth unit pixels U₂, U₃, and U₄ may have a structure that is similar to a structure of the first unit pixel U₁, but is rotated. For example, the first unit pixel U₁ may be arranged according to a first structure, the second unit pixel U₂ may be arranged according to a second structure that is rotated by 90 degrees in a clockwise direction with respect to the first structure, the third unit pixel U₃ may be arranged according to a third structure that is rotated by 270 degrees in the clockwise direction with respect to the first structure, and the fourth unit pixel U₄ may be arranged according to according to a fourth structure that is rotated by 180 degrees in the clockwise direction with respect to the first structure.

The first pixel (e.g., the red pixel R) is provided in the first row and first column of the first unit pixel U₁, the first row and second column of the second unit pixel U₂, the second row and the first column of the third unit pixel U₃, and the second row and second column of the fourth unit pixel U₄. The second pixel (e.g., the blue pixel B) is provided in the second row and second column of the first unit pixel U₁, the second row and first column of the second unit pixel U₂, the first row and the second column of the third unit pixel U₃, and the first row and first column of the fourth unit pixel U₄. The third pixel (e.g., the one green pixel G) is provided in the second row and first column of the first unit pixel U₁, the first row and first column of the second unit pixel U₂, the second row and the second column of the third unit pixel U₃, and the first row and second column of the fourth unit pixel U₄. The fourth pixel (e.g., another green pixel G) is provided in the first row and second column of the first unit pixel U₁, the second row and second column of the second unit pixel U₂, the first row and the first column of the third unit pixel U₃, and the second row and first column of the fourth unit pixel U₄.

Referring to FIG. 7, the second to fourth unit pixels U₂, U₃, and U₄ may have a structure that is similar to a structure of the first unit pixel U₁, but is flipped. The flipped structure may refer to an arrangement in which a unit pixel arrangement as a reference is exchanged based on any one of a first direction (e.g., the X direction), a second direction (e.g., the Y direction), and a diagonal direction. For example, the first unit pixel U₁ may be arranged according to a first structure, the second unit pixel U₂ may be arranged according to a second structure in which the first and second rows are exchanged with each other and flipped in the first direction (e.g., the X direction) with respect to the first structure. The third unit pixel U₃ may be arranged according to a third structure in which the first and second columns of the first unit pixel U₁ are exchanged with each other and flipped in the second direction (e.g., the Y direction) with respect to the first structure. The fourth unit pixel U₄ may be arranged according to a fourth structure in which the pixels are exchanged with respect to a diagonal line and flipped arranged according to a second structure.

The first pixel (e.g., the red pixel R) is provided in the first row and first column of the first unit pixel U₁, the second row and first column of the second unit pixel U₂, the first row and the second column of the third unit pixel U₃, and the second row and second column of the fourth unit pixel U₄. The second pixel (e.g., the blue pixel B) is provided in the second row and second column of the first unit pixel U₁, the first row and second column of the second unit pixel U₂, the second row and the first column of the third unit pixel U₃, and the first row and first column of the fourth unit pixel U₄. The third pixel (e.g., one green pixel G) is provided in the second row and first column of the first unit pixel U₁, the first row and first column of the second unit pixel U₂, the second row and the second column of the third unit pixel U₃, and the first row and second column of the fourth unit pixel U₄. The fourth pixel (e.g., another green pixel G) is provided in the first row and second column of the first unit pixel U₁, the second row and second column of the second unit pixel U₂, the first row and the first column of the third unit pixel U₃, and the second row and first column of the fourth unit pixel U₄.

Regarding FIGS. 2 to 7, examples are described in which one unit pattern includes unit pixels in a 2×2 arrangement, and one unit pixel includes a 2×2 arrangement quadrant area, and thus, one unit pattern arrangement is a 4×4 arrangement, but embodiments are not limited thereto, and the unit pattern arrangement may have various arrangements. For example, one unit pattern may include a unit pixel arrangement having a 2×2 arrangement, and one unit pixel arrangement may have a 3×3 arrangement region or a 4×4 arrangement region. When the unit pixel arrangement has a 3×3 arrangement region, one unit pattern may be a 6×6 arrangement, and when the unit pixel arrangement has a 4×4 arrangement region, one unit pattern may be an 8×8 arrangement. In this case, similar to the examples described above, one unit pattern may include a rotation structure or a flip structure of a unit pixel arrangement. A unit pattern including a rotation structure or a flip structure of a unit pixel arrangement may be repeatedly arranged in two dimensions in a first direction (e.g., the X direction) and a second direction (e.g., the Y direction).

The image sensor 1000 including the color separation lens array 140 may acquire a disparity of an image generated by pixels for each color by including a pixel array (e.g., the pixel array 1100 illustrated in FIG. 2, illustrated 1101 illustrated in FIG. 6, and illustrated 1102 illustrated in FIG. 7) having a rotation structure or flip structure as described above, and may generate depth information and a depth map, which may denote or indicate distance information between the image sensor 1000 and the subject, and perform an autofocus function based on the acquired disparity. In addition, the image sensor 1000 including the color separation lens array 140 may include a pixel array (e.g., the pixel array 1100 illustrated in FIG. 2, the pixel array 1101 of FIG. 6, or the pixel array 1102 illustrated FIG. 7) having a rotation structure or a flip structure as described above, and thus, an image having different disparity for each of pixels of all colors (e.g., red pixels R, green pixels G, and blue pixels B) may be acquired. In embodiments, disparity may refer to a difference or distance between a position of an image feature in a first image and a position of the same image feature in a second image.

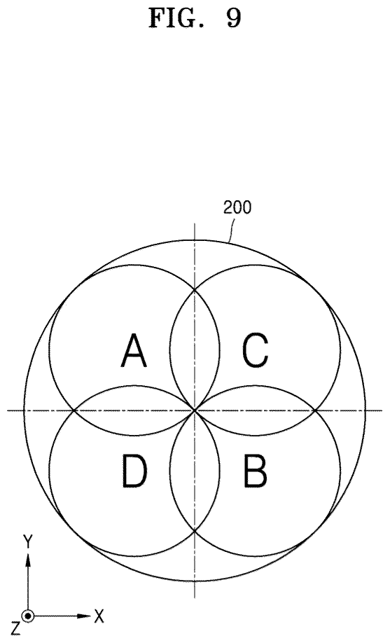

FIGS. 8 and 9 are views illustrating a disparity occurring due to a phase difference for each color of each pixel of an image sensor according to an embodiment and a view angle relationship for each pixel due to the disparity, respectively. For convenience, description is made based on the arrangement of the pixel array 1100 of FIG. 2.

In order to acquire a phase difference signal for each color, images having different disparities corresponding to four regions (e.g., a region A, a region B, a region C, and a region D) in an objective lens 200 of FIG. 9 may be secured for a channel of the same color. Hereinafter, for convenience, a description is given based on a red pixel R, and a relationship in which a subject and a captured image are turned upside down is omitted for convenience of description.

A first image corresponding to the region A of the objective lens 200 of FIG. 9 may be acquired from the red pixels R corresponding to the region A of FIG. 8. second image corresponding to the region B of the objective lens 200 of FIG. 9 may be acquired from the red pixels R corresponding to the region B of FIG. 8. A third image corresponding to the region C of the objective lens 200 of FIG. 9 may be acquired from the red pixels R corresponding to the region C of FIG. 8. A fourth image corresponding to the region D of the objective lens 200 of FIG. 9 may be acquired from the red pixels R corresponding to the region D of FIG. 8. Therefore, images (first to fourth images) having different disparities with respect to the red channel may be acquired.

According to embodiments, when the optical diffuser 150 is used, the four regions A, B, C, and D in the objective lens 200 of FIG. 9 may be widened. When the optical diffuser 150 removes all of the directionality of incident light, the centers of the four regions A, B, C, and D in the objective lens 200 may be the same as the center of the objective lens 200, and the area of the four regions A, B, C, and D may be similar to the area of the objective lens 200. However, unless the directionality of the incident light is completely removed, the center of the four regions A, B, C, and D in the objective lens 200 may not be the same as the center of the objective lens 200, and thus, the image corresponding to each region may have a disparity. The image sensor 1000 according to an embodiment may measure a distance between a subject and a sensor using images having disparity, and may perform an autofocus function based on a measurement result.

In the image sensor 1000, the first image corresponding to the region A and the third image corresponding to the region C correspond to a horizontal binocular stereo image. The image sensor 1000 may acquire a first phase difference signal (e.g., a left and right phase difference signal) from the first image corresponding to the region A and the third image corresponding to the region C, and acquire a first disparity (e.g., a horizontal disparity) therefrom. For example, the first disparity (e.g., the horizontal disparity) may be measured by measuring whether the third image is most similar to the first image when the third image corresponding to the region C is moved left or right by a particular number of pixels based on the first image corresponding to the region A.

The image sensor 1000 may measure a horizontal distance to the subject according to triangulation from the acquired horizontal disparity.

Similarly, in the image sensor 1000, the first image corresponding to the region A and the fourth image corresponding to the region D correspond to a vertical binocular stereo image. The image sensor 1000 may acquire a second phase difference signal (e.g., a top and bottom phase difference signal) from the first image corresponding to the region A and the fourth image corresponding to the region D, and acquire a second disparity (e.g., a vertical disparity) therefrom. For example, the second disparity (e.g., the vertical disparity) may be measured by measuring whether the fourth image is most similar to the first image when the fourth image corresponding to the region D is moved up or down by how many pixels based on the first image corresponding to the region A.

The image sensor 1000 may measure a vertical distance to the subject according to triangulation from the acquired vertical disparity.

In addition, the image sensor 1000 may acquire a diagonal disparity from the first image corresponding to the region A and the second image corresponding to the region B. In addition, the image sensor 1000 may acquire another diagonal disparity from the third image corresponding to the region C and the fourth image corresponding to the region D. In some embodiments, the diagonal disparity may be acquired using the acquired horizontal disparity and vertical disparity.

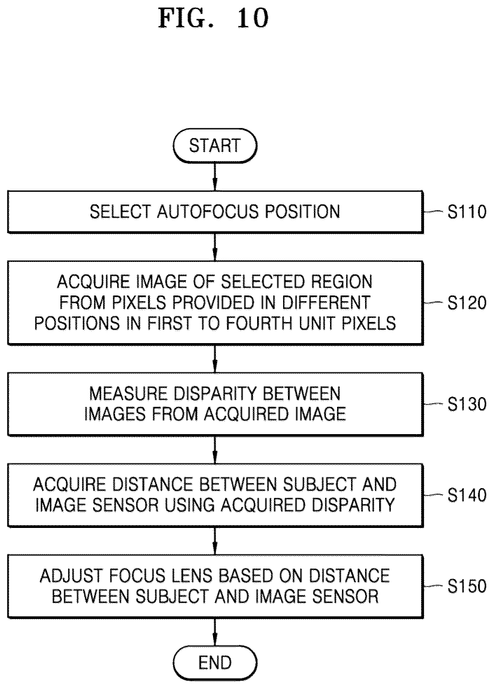

FIG. 10 is a flowchart illustrating a method of performing an autofocus function according to an embodiment.

Referring to FIG. 10, a method of performing an autofocus function may be as follows. First, an autofocus position is selected at operation S110. The autofocus position selection may be performed, for example, generally at a central portion of a screen, or may be performed by a user touching a smartphone screen. After selecting the autofocus position, an image of the selected region may be acquired from pixels provided at different positions within the first to fourth unit pixels at operation S120. In this case, only the selected region may capture an image at 120 Hertz (Hz). A disparity between images is measured by using images acquired from pixels provided at different positions in the first to fourth unit pixels at operation S130. For example, images taken from pixels at different positions in the first to fourth unit pixels are separated into upper and lower (e.g., vertical) or left and right (e.g.,, horizontal) phase difference signals in each frame to acquire images with different disparities, and the disparity between images is measured from images with different disparities.

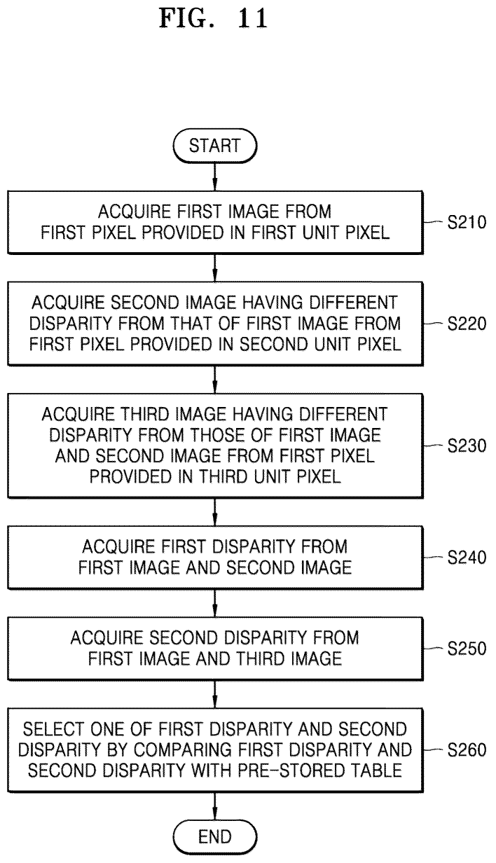

FIG. 11 is a flowchart illustrating acquiring an inter-image disparity of FIG. 10 according to an embodiment.

Referring to FIG. 11, the operation S130 of measuring the disparity between images of FIG. 10 may be performed as follows. The first image may be acquired from the first pixel provided in the first unit pixel at operation S210. The second image having a different disparity from the first image may be acquired from the first pixel provided in the second unit pixel at operation S220. The third image having a different disparity from the first image and the second image may be acquired from the first pixel provided in the third unit pixel at operation S230. The first disparity (e.g., the horizontal disparity) may be acquired from the first image and the second image at operation S240, and the second disparity (e.g., the vertical disparity) may be acquired from the first image and the third image at operation S250.

According to embodiments, there may be a subject that is located at a relatively extreme position vertically or horizontally in a captured image, and thus a difference in reliability may occur. Therefore, it is possible to compare whether the vertical disparity or the horizontal disparity is more reliable. The relationship between the distance between the subject and the image sensor according to vertical or horizontal disparity may be stored in a table in advance. A disparity having a relatively higher reliability may be selected by comparing and evaluating the first disparity and the second disparity with the disparity of the stored table at operation S260.

Referring back to FIG. 10, a distance between the subject and the image sensor may be calculated using a pre-stored table from the acquired disparity at operation S140, and then, a focus lens for autofocus among the lenses of the camera may be moved to a position where the focus is improved based on the calculated distance between the subject and the image sensor at operation S150. If the focus lens moves forward or backward to some extent, it may be stored in a table in advance to see how far the focus is from the camera. As described above, the image sensor 1000 may acquire images having different disparities from red pixels R corresponding to each region, and the camera including the image sensor 1000 may extract a phase difference signal from images having different disparities, acquire depth information and a depth map based on the same, and perform an autofocus function.

Although examples are described above in which the red pixels R are used, the image sensor 1000 may similarly acquire images with different disparities for each color (e.g., for the blue pixels B and the green pixels G in addition to the red pixels R), extract a phase difference signal, extract depth information and a depth map based on this phase difference signal, and perform an autofocus function.

In addition, because pixels corresponding to the corresponding regions exist in the case of the green pixels G within one unit pattern, depth information may be acquired by generating images having different disparities from pixels corresponding to one of the green pixels G of the unit pixel, and depth information may be acquired by generating images having different disparities from pixels corresponding to the other of the green pixels G of the unit pixel, and then, the acquired depth information may be compared and reviewed.

In some embodiments, autofocusing may be performed by generating images having different disparities from pixels corresponding to one or the other of the green pixels G of the unit pixel to acquire more precise depth information and depth maps.

Examples of the image sensor including the color separation lens array described above are described with reference to the embodiments shown in the drawings, but these are only examples, and those of ordinary skill in the art will understand that various modifications and equivalent other embodiments are possible. Therefore, the disclosed embodiments should be considered from an explanatory point of view rather than a limiting point of view. The scope of the disclosure is defined not by the detailed description but by the appended claims, and all differences within the scope will be construed as being included in the scope of the disclosure.

The pixel array of an image sensor including the color separation lens array described above may include unit patterns with various rotating structures or flip structures, to thereby acquire an image with different disparities for each pixel of each color, acquire a phase difference signal, and based on this, acquire depth information and depth maps and perform an autofocus function. Such image sensors may be employed in various high-performance optical devices or high-performance electronic apparatuses. The electronic apparatuses may be, for example, smart phones, mobile phones, portable phones, personal digital assistants (PDAs), laptops, personal computers (PCs), various portable devices, home appliances, security cameras, medical cameras, vehicles, Internet of Things (IoT) devices, augmented reality (AR) devices, virtual reality (VR) devices, various types of extended reality devices that expand the user's experience, other mobile or non-mobile computing devices, and are not limited thereto.

In addition to the image sensor 1000, the electronic apparatus may further include a processor that controls the image sensor, for example, an application processor (AP), and may drive an operating system or application program, through the processor, to control a number of hardware or software components and perform various data processes and operations. The processor may further include a graphical processing unit (GPU) and/or an image signal processor. When an image signal processor is included in the processor, an image (or video) acquired by the image sensor may be stored and/or output using the processor.

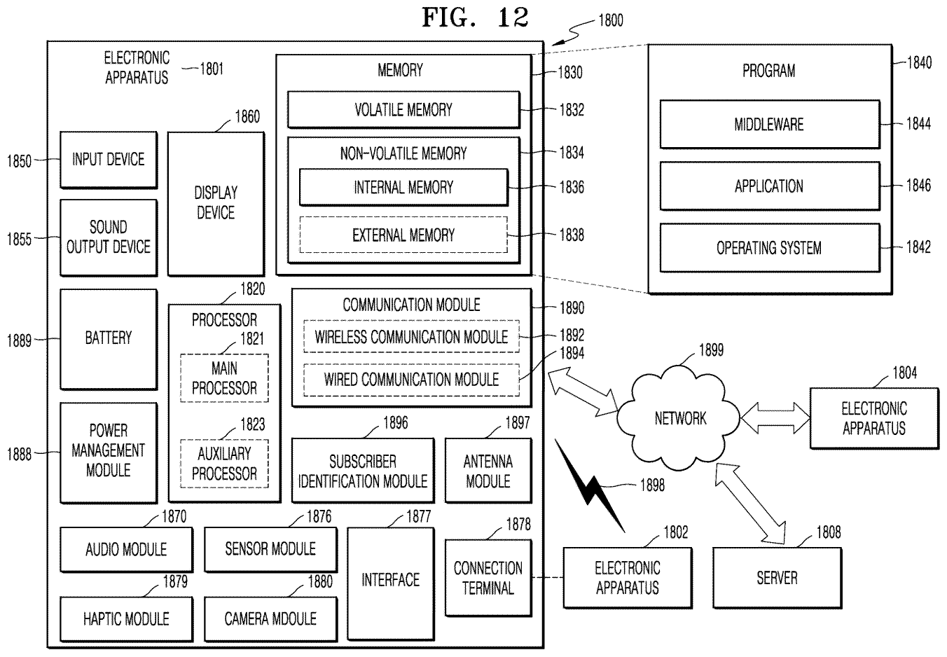

FIG. 12 is a block diagram illustrating an example of an electronic apparatus including an image sensor.

Referring to FIG. 12, under a network environment 1800, the electronic apparatus 1801 may communicate with another electronic apparatus 1802 using a first network 1898 (a short-range wireless communication network, etc.), or may communicate with another electronic apparatus 1804 and/or a server 1808 using a second network 1899 (a long-range wireless communication network, etc.). The electronic apparatus 1801 may communicate with the electronic apparatus 1804 through the server 1808. The electronic apparatus 1801 may include a processor 1820, a memory 1830, an input device 1850, an audio output device 1855, a display device 1860, an audio module 1870, a sensor module 1876, an interface 1877, a haptic module 1879, a camera module 1880, a power management module 1888, a battery 1889, a communication module 1890, a subscriber identification module 1896, and/or an antenna module 1897. Some of these components (e.g., the display device 1860, and the like) may be omitted from or other components may be added to the electronic apparatus 1801. Some of these components may be implemented as one integrated circuit. For example, the sensor module 1876 (e.g., a fingerprint sensor, an iris sensor, an illuminance sensor, etc.) may be implemented by being embedded in the display device 1860 (e.g., a display, etc.).

The processor 1820 may execute software (program 1840 or the like) to control one or a plurality of other components (e.g., hardware components, software components, etc.) of the electronic apparatus 1801 connected to the processor 1820, and may perform various data processing or operations. As part of data processing or operation, the processor 1820 may load commands and/or data received from other components (e.g., the sensor modules 1876, the communication modules 1890, etc.), process commands and/or data stored in volatile memory 1832, and store the result data in nonvolatile memory 1834. The processor 1820 may include a main processor 1821 (e.g., a central processing unit, an application processor, etc.) and an auxiliary processor 1823 (e.g., a graphics processing unit, an image signal processor, a sensor hub processor, a communication processor, etc.) that may be operated independently of or together with the main processor 1821. The auxiliary processor 1823 may use less power than the main processor 1821 and perform a specialized function.

The auxiliary processor 1823 may control the functionality and/or status associated with some of the components of the electronic apparatus 1801 (e.g., the display device 1860, the sensor module 1876, the communication module 1890, etc.), in place of the main processor 1821 while the main processor 1821 is in an inactive state (e.g., a sleep state), or in conjunction with the main processor 1821 while the main processor 1821 is in an active state (e.g., an application execution state). The auxiliary processor 1823 (e.g., an image signal processor, a communication processor, etc.) may be implemented as part of other functionally related components (e.g., the camera module 1880, the communication module 1890, etc.).

The memory 1830 may store various data required by components (e.g., the processor 1820 and the sensor module 1876) of the electronic apparatus 1801. The data may include, for example, input data and/or output data for software (e.g., the program 1840 or the like) and related commands. The memory 1830 may include a volatile memory 1832 and/or a nonvolatile memory 1834.

The program 1840 may be stored in the memory 1830 as software, and may include an operating system 1842, middleware 1844, and/or an application 1846.

The input device 1850 may receive commands and/or data to be used in components (e.g., the processor 1820, etc.) of the electronic apparatus 1801 from an outside (e.g., a user, etc.) of the electronic apparatus 1801. The input device 1850 may include a microphone, a mouse, a keyboard, and/or a digital pen (such as a stylus pen).

The sound output device 1855 may output the sound signal to the outside of the electronic apparatus 1801. The sound output device 1855 may include a speaker and/or a receiver. Speakers may be used for general purposes such as multimedia playback or recording playback, and receivers may be used to receive incoming calls. The receiver may be coupled as part of a speaker or may be implemented as an independent separate device.

The display device 1860 may visually provide information to the outside of the electronic apparatus 1801. The display device 1860 may include a display, a hologram device, or a projector and a control circuit for controlling the corresponding device. The display device 1860 may include a touch circuit configured to sense a touch, and/or a sensor circuit (e.g., a pressure sensor, etc.) configured to measure an intensity of a force generated by the touch.

The audio module 1870 may convert sound into an electrical signal or conversely convert the electrical signal into sound. The audio module 1870 may acquire sound through the input device 1850 or output sound through the sound output device 1855 and/or a speaker and/or a headphone of another electronic apparatus (e.g., the electronic apparatus 1802, etc.) directly or wirelessly connected to the electronic apparatus 1801.

The sensor module 1876 may detect an operating state (e.g., power, temperature, etc.) or an external environmental state (e.g., a user state, etc.) of the electronic apparatus 1801 and generate an electrical signal and/or a data value corresponding to the sensed state. The sensor module 1876 may include a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illumination sensor.

The interface 1877 may support one or more designated protocols that may be used for electronic apparatus 1801 to be directly or wirelessly connected to another electronic apparatus (e.g., the electronic apparatus 1802, etc.). The interface 1877 may include a high definition multimedia interface (HDMI), a universal serial bus (USB) interface, an SD card interface, and/or an audio interface.

The connection terminal 1878 may include a connector through which the electronic apparatus 1801 may be physically connected to another electronic apparatus (e.g., the electronic apparatus 1802, etc.). The connection terminal 1878 may include an HDMI connector, a USB connector, an SD card connector, and/or an audio connector (such as a headphone connector, etc.).

The haptic module 1879 may convert an electrical signal to a mechanical stimulus (e.g., vibration, motion, etc.) or an electrical stimulus that a user can recognize through a tactile or motion sensation. The haptic module 1879 may include a motor, a piezoelectric element, and/or an electrical stimulus.

The camera module 1880 may capture a still image and a moving image. The camera module 1880 may include a lens assembly including one or more lenses, a spectral image sensor 1000 of FIG. 1, image signal processors, and/or flashes. The lens assembly included in the camera module 1880 may collect light emitted from a subject to be photographed.

The power management module 1888 may manage power supplied to the electronic apparatus 1801. The power management module 1888 may be implemented as part of a power management integrated circuit (PMIC).

The battery 1889 may supply power to components of the electronic apparatus 1801. The battery 1889 may include a non-rechargeable primary battery, a rechargeable secondary battery, and/or a fuel cell.

The communication module 1890 may establish a direct (e.g., wired) communication channel and/or wireless communication channel between the electronic apparatus 1801 and another electronic apparatus (e.g., the electronic apparatus 1802, the electronic apparatus 1804, the server 1808, etc.), and support communication execution through the established communication channel. The communication module 1890 may include one or more communication processors that operate independently of the processor 1820 (e.g., an application processor, etc.) and support direct communication and/or wireless communication. The communication module 1890 may include a wireless communication module 1892 (a cellular communication module, a short-range wireless communication module, a global navigation satellite system (GNSS) communication module, and/or a wired communication module 1894 (e.g., a local area network (LAN) communication module, a power line communication module, etc.). A corresponding communication module of these communication modules may communicate with other electronic apparatuses through a first network 1898 (a short-range communication network such as Bluetooth, WiFi Direct, or infrared data association (IrDA)), or a second network 1899 (a long-range communication network such as a cellular network, Internet, or computer network (e.g., a LAN, a WAN, etc.)). These various types of communication modules may be integrated into a single component (such as a single chip, etc.), or may be implemented as a plurality of separate components (e.g., multiple chips). The wireless communication module 1892 may identify and authenticate the electronic apparatus 1801 in a communication network such as a first network 1898 and/or a second network 1899 using subscriber information (such as an international mobile subscriber identifier (IMSI) stored in the subscriber identification module 1896.

The antenna module 1897 may transmit a signal and/or power to the outside (such as another electronic apparatus, etc.) or receive the signal and/or power from the outside. The antenna may include a radiator formed of a conductive pattern formed on the substrate (PCB, etc.). The antenna module 1897 may include one or a plurality of antennas. When a plurality of antennas are included, an antenna suitable for a communication scheme used in a communication network such as a first network 1898 and/or a second network 1899 may be selected from among the plurality of antennas by the communication module 1890. A signal and/or power may be transmitted or received between the communication module 1890 and another electronic apparatus through the selected antenna. Other components (e.g., a radio-frequency integrated circuit (RFIC), etc.) in addition to the antenna may be included as a part of the antenna module 1897.

Some of the components may be connected to each other using communication methods between peripherals (such as buses, General Purpose Input and Output (GPIO), Serial Peripheral Interface (SPI), and Mobile Industry Processor Interface (MIPI), etc.) to interchange signals (commands, data, etc.).

The command or data may be transmitted or received between the electronic apparatus 1801 and the external electronic apparatus 1804 through the server 1808 connected to the second network 1899. Other electronic apparatuses 1802 and 1804 may be the same or different types of apparatuses as the electronic apparatus 1801. All or some of the operations executed in the electronic apparatus 1801 may be executed in one or more of the other electronic apparatuses 1802, 1804, and 1808. For example, when the electronic apparatus 1801 needs to perform a function or service, it may request one or more other electronic apparatuses to perform part or all of the function or service instead of executing the function or service on its own. One or more other electronic apparatuses receiving the request may execute an additional function or service related to the request and transmit a result of the execution to the electronic apparatus 1801. Therefore, cloud computing, distributed computing, and/or client-server computing technology may be used.

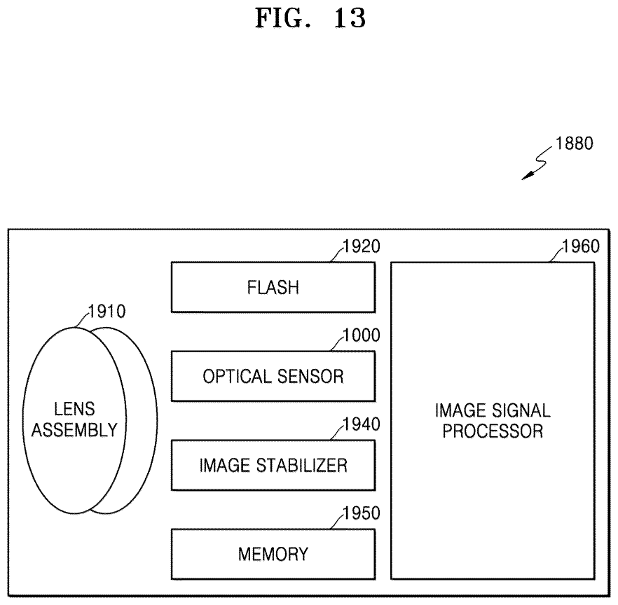

FIG. 13 is a block diagram illustrating a camera module of FIG. 12.

Referring to FIG. 13, the camera module 1880 may include a lens assembly 1910, a flash 1920, an image sensor 1000 (as shown for example in FIG. 1), an image stabilizer 1940, a memory 1950 (buffer memory, etc.), and/or an image signal processor (ISP) 1960. The lens assembly 1910 may collect light emitted from a subject to be imaged. The camera module 1880 may include a plurality of lens assemblies 1910, and in this case, the camera module 1880 may be or may include at least one of a dual camera, a 360-degree camera, and a spherical camera. Some of the plurality of lens assemblies 1910 may have the same lens properties (e.g., view angle, focal length, autofocus, F-stop Number, optical zoom, etc.), or may have different lens properties. The lens assembly 1910 may include a wide-angle lens or a telephoto lens.

The flash 1920 may emit light used to enhance light emitted or reflected from the subject. The flash 1920 may include one or more light emitting diodes (e.g., Red-Green-Blue (RGB) LED, White LED, Infrared LED, Ultraviolet LED, etc.), and/or Xenon Lamps. The image sensor 1000 may correspond to the image sensor described in FIG. 1, and may acquire an image corresponding to a subject by converting light emitted or reflected from the subject and transmitted through the lens assembly 1910 into an electrical signal. The image sensor 1000 may include one or a plurality of sensors selected from image sensors having different attributes, such as an RGB sensor, a black and white (BW) sensor, an infrared (IR) sensor, or an ultraviolet (UV) sensor. Each of the sensors included in the image sensor 1000 may be implemented as a charge coupled device (CCD) sensor and/or a Complementary Metal Oxide Semiconductor (CMOS) sensor.

In response to the movement of the camera module 1880 or the electronic apparatus 1801 including the same, the image stabilizer 1940 may move the one or more lenses or the image sensor 1000 included in the lens assembly 1910 in a specific direction or control an operation characteristic (adjustment of read-out timing and the like) of the image sensor 1000 to compensate for a negative impact caused by the movement. The image stabilizer 1940 may detect the movement of the camera module 1880 or the electronic apparatus 1801 by using a gyro sensor (not shown) or an acceleration sensor (not shown) arranged inside or outside the camera module 1880. The image stabilizer 1940 may be implemented optically.

The memory 1950 may store some or all data of an image acquired through the image sensor 1000 for a next image processing operation. For example, when multiple images are acquired at high speed, the acquired original data (e.g., Bayer-Patterned data, high-resolution data, etc.) may be stored in the memory 1950, and used to allow only low-resolution images to displayed, and then the original data of the selected image (e.g., user selection, or the like) to be transferred to the ISP 1960. The memory 1950 may be integrated into the memory 1830 of the electronic apparatus 1801, or may be configured as a separate memory that operates independently.

The ISP 1960 may perform image processes on image acquired through the spectral image sensor 1000 or image data stored in the memory 1950. The image processes may include depth map generation, three-dimensional modeling, panorama generation, feature point extraction, image synthesis, and/or image compensation (noise reduction, resolution adjustment, brightness adjustment, blurring interpolation, sharpening, softening, etc.). The ISP 1960 may perform control (e.g., exposure time control, read-out timing control, etc.) on components (e.g., the image sensor 1000, etc.) included in the camera module 1880. The image processed by the ISP 1960 may be re-stored in the memory 1950 for further processing or may be provided to an external component of the camera module 1880 (e.g., the memory 1830, the display device 1860, the electronic apparatus 1802, the electronic apparatus 1804, the server 1808, etc.). The ISP 1960 may be integrated into the processor 1820 or may be configured as a separate processor that operates independently of the processor 1820. When the ISP 1960 is configured as a separate processor from the processor 1820, the image processed by the ISP 1960 may be displayed through the display device 1860 after additional image processing by the processor 1820.

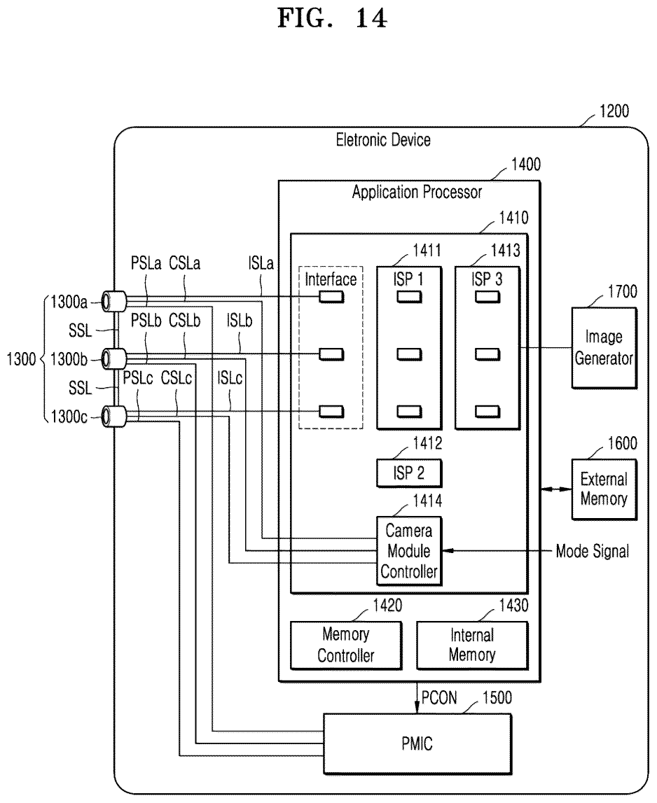

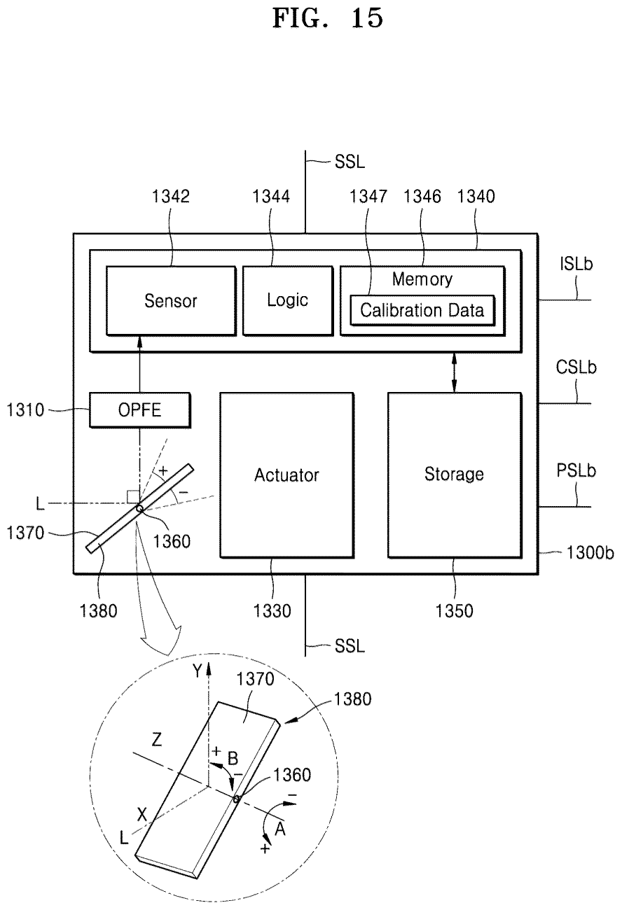

FIG. 14 is a block diagram of an electronic apparatus including a multi-camera module, and FIG. 15 is a detailed block diagram of a camera module of the electronic device illustrated in FIG. 14.

Referring to FIG. 14, an electronic device 1200 may include a camera module group 1300, an application processor 1400, a power management integrated circuit (PMIC) 1500, an external memory 1600, and an image generator 1700.

The camera module group 1300 may include a plurality of camera modules (e.g., a camera module 1300a, a camera module 1300b, and a camera module 1300c). Although an example in which three camera modules 1300a, 1300b and 1300c are arranged is illustrated in FIG. 14, embodiments are not limited thereto. For example, in some embodiments, the camera module group 1300 may be modified to include only two camera modules. In addition, in some embodiments, camera module group 1300 may be modified to include n camera modules (n is a natural number of 4 or more).

Hereinafter, with reference to FIG. 15, an example of the detailed configuration of the camera module 1300b is described in more detail, but the following description may be equally applied to other camera modules 1300a and 1300c depending on embodiments.

Referring to FIG. 15, the camera module 1300b may include a prism 1380, an optical path folding element (OPFE) 1310, an actuator 1330, an image sensing device 1340, and a storage unit 1350.

The prism 1380 may include a reflective surface 1370 of a light reflecting material to transform a path of light L incident from the outside.

In some embodiments, the prism 1380 may change a path of light L incident in a first direction X to a second direction Y perpendicular to the first direction X. In addition, the prism 1380 may change the path of light L incident in the first direction X to a vertical second direction Y by rotating the reflective surface 1370 of the light reflecting material in a direction A around the central axis 1360, or rotating the central axis 1360 in a direction B. In this case, the OPFE 1310 may also move in a third direction Z perpendicular to the first direction X and the second direction Y.

In some embodiments, as illustrated, the maximum rotation angle of the prism 1380 in the direction A may be 15 degrees or less in a plus (+) direction of the direction A and may be greater than 15 degrees in a minus (−) direction of the direction A, but embodiments are not limited thereto.

In some embodiments, the prism 1380 may move around 20 degrees, or between 10 and 20 degrees, or between 15 and 20 degrees, in a positive (+) or negative (−) direction of the direction B, where the moving angle may move at the same angle in a positive (+) or negative (−) direction of the direction B, or to a nearly similar angle in a range of around 1 degree.

In some embodiments, the prism 1380 may move the reflective surface 1370 of the light reflective material in a third direction (e.g., a Z direction) parallel to the extending direction of the central axis 1360.

The OPFE 1310 may include, for example, optical lenses consisting of m groups of lenses (where m is a natural number). The m groups of lenses may be moved in the second direction Y to change an optical zoom ratio of the camera module 1300b. For example, if the basic optical zoom ratio of the camera module 1300b is Z, and m groups of optical lenses included in the OPFE 1310 are moved, the optical zoom ratio of the camera module 1300 b may be changed to an optical zoom ratio of 3Z, 5Z, or 10Z or more.

The actuator 1330 may move the OPFE 1310 or the optical lens (which may be referred to as the optical lens) to a specific position. For example, the actuator 1330 may adjust the position of the optical lens so that an image sensor 1342 is located at the focal length of the optical lens for accurate sensing.

The image sensing device 1340 may include the image sensor 1342, a control logic 1344, and a memory 1346. The image sensor 1342 may sense an image of a subject to be sensed using light L provided through the optical lens. The control logic 1344 may control the overall operation of the camera module 1300b. For example, the control logic 1344 may control the operation of the camera module 1300b according to a control signal provided through a control signal line CSLb.

The memory 1346 may store information necessary for the operation of the camera module 1300b, such as calibration data 1347. The calibration data 1347 may include information necessary to generate image data by using the light L provided from the outside through the camera module 1300b. The calibration data 1347 may include, for example, information about a degree of rotation, information on a focal length, information about an optical axis, and the like described above. When the camera module 1300b is implemented in the form of a multi-state camera whose focal length changes according to the position of the optical lens, the calibration data 1347 may include a focal length value for each position (or state) of the optical lens and information related to autofocus.

The storage unit 1350 may store image data sensed through the image sensor 1342. The storage unit 1350 may be arranged outside the image sensing device 1340, and may be implemented in a stacked form with a sensor chip constituting the image sensing device 1340. In some embodiments, the storage unit 1350 may be implemented as an electrically erasable programmable read-only memory (EEPROM), but embodiments are not limited thereto.

Referring to FIGS. 14 and 15, in some embodiments, each of the camera modules 1300a, 1300b, and 1300c may include the actuator 1330. Accordingly, each of the camera modules 1300a, 1300b, and 1300c may include the same or different calibration data 1347 according to the operation of the actuator 1330 included therein.

In some embodiments, one camera module (e.g., the camera module 1300b) of the camera modules 1300a, 1300b, and 1300c may be a camera module in the form of a folded lens including the prism 1380 and the OPFE 1310 described above, and the remaining camera modules (e.g., the camera module 1300a and the camera module 1300b) may be vertical camera modules without the prism 1380 and the OPFE 1310, but embodiments are not limited thereto.

In some embodiments, one camera module (e.g., the camera module 1300c) of the camera modules 1300a, 1300b, and 1300c may be, for example, a vertical depth camera extracting depth information using an Infrared Ray (IR).

In some embodiments, at least two of the camera modules 1300a, 1300b, and 1300c (e.g., the camera module 1300a and the camera module 1300b) may have different fields of view or different viewing angles. In this case, for example, the optical lenses of at least two of the camera modules 1300a, 1300b, and 1300c may be different from each other, but embodiments are not limited thereto.

In addition, in some embodiments, the fields of view or the viewing angles of the camera modules 1300a, 1300b, and 1300c may be different from each other. In this case, optical lenses included in the camera modules 1300a, 1300b, and 1300c may also be different from each other, but embodiments are not limited thereto.

In some embodiments, the camera modules 1300a, 1300b, and 1300c may be physically separated from each other. For example, rather than using the sensing area of one image sensor 1342 divided by the camera modules 1300a, 1300b, and 1300c, an independent image sensor 1342 may be arranged inside each of the camera modules 1300a, 1300b, and 1300c.

Referring back to FIG. 14, the application processor 1400 may include an image processing device 1410, a memory controller 1420, and an internal memory 1430. The application processor 1400 may be implemented separately from the camera modules 1300a, 1300b, and 1300c. For example, the application processor 1400 and the camera modules 1300a, 1300b, and 1300c may be implemented separately from each other by separate semiconductor chips.

The image processing device 1410 may include a plurality of image processors (e.g., image processor 1411, image processor 1412, and image processor 1413), and a camera module controller 1414.

The image data generated from each of the camera modules 1300a, 1300b, and 1300c may be provided to the image processing device 1410 through image signal lines ISLa, ISLb, and ISLc separated from each other. For example, this image data transmission may be performed using a camera serial interface (CSI) based on a mobile industry processor interface (MIPI), but embodiments are not limited thereto.

The image data transmitted to the image processing device 1410 may be stored in the external memory 1600 before being transmitted to the image processors 1411 and 1412. Image data stored in the external memory 1600 may be provided to the image processor 1411 and/or the image processor 1412. The image processor 1411 may correct the received image data to generate a motion image. The image processor 1412 may correct the received image data to generate a still image. For example, the image processors 1411 and 1412 may perform preprocessing operations such as color correction and gamma correction on image data.

The image processor 1411 may include sub-processors. When the number of sub-processors is the same as the number of camera modules 1300a, 1300b, and 1300c, each of the sub-processors may process image data provided from one camera module. When the number of sub-processors is less than the number of camera modules 1300a, 1300b, and 1300c, at least one of the sub-processors may process image data provided from the plurality of camera modules using a time sharing process. The image data processed by the image processor 1411 and/or the image processor 1412 may be stored in the external memory 1600 before being transmitted to the image processor 1413. Image data stored in the external memory 1600 may be transmitted to the image processor 1413. The image processor 1413 may perform a post-processing operation, such as noise correction and sharpening correction, on the image data.

Image data processed by the image processor 1413 may be provided to the image generator 1700. The image generator 1700 may generate a final image by using image data provided from the image processor 1413 according to image generating information or a mode signal.

For example, the image generator 1700 may generate an output image by merging at least some of the image data generated from the camera modules 1300a, 1300b, and 1300c having different fields of view or viewing angles according to the image generating information or the mode signal. In addition, the image generator 1700 may generate an output image by selecting any one of image data generated from camera modules 1300a, 1300b, and 1300c with different fields of view or viewing angles according to image generating information or mode signal.

In some embodiments, the image generating information may include a zoom signal or a zoom factor. In addition, in some embodiments, the mode signal may be, for example, a signal based on a mode selected by a user.

When the image generating information is a zoom signal (a zoom factor), and each of the camera modules 1300a, 1300b, and 1300c has different fields of view (or different viewing angles), the image generator 1700 may perform different operations according to the type of zoom signal. For example, if the zoom signal is a first signal, the image data output from the camera module 1300a and the image data output from the camera module 1300c may be merged, and then the merged image signal and the image data output from the camera module 1300b which is not used for the image data merging may be used to generate an output image. If the zoom signal is a second signal different from the first signal, the image generator 1700 may generate an output image by selecting any one of the image data output from each of the camera modules 1300a, 1300b, and 1300c without performing such image data merging. However, embodiments are not limited thereto, and a method of processing image data as necessary may be modified and implemented.

The camera module controller 1414 may provide a control signal to each of the camera modules 1300a, 1300b, and 1300c. The control signals generated from the camera module controller 1414 may be provided to the corresponding camera modules 1300a, 1300b, and 1300c through control signal lines CSLa, CSLb, and CSLc separated from each other.

In some embodiments, the control signals provided from the camera module controller 1414 to the plurality of camera modules 1300a, 1300b, and 1300c may include mode information according to the mode signal. Based on the mode information, the plurality of camera modules 1300a, 1300b, and 1300c may operate in a first operation mode and a second operation mode in relation to a sensing speed.

In the first operation mode, the plurality of camera modules 1300a, 1300b, and 1300c may generate an image signal at a first speed (e.g., generate an image signal at a first frame rate), encode the generated image signal at a second speed higher than the first speed (e.g., encode an image signal at a second frame rate higher than the first frame rate), and transmit the encoded image signal to the application processor 1400. In this case, the second speed may be 30 times or less of the first speed.

The application processor 1400 may store the received image signal, that is, the encoded image signal, in the memory 1430 provided therein or the external memory 1600 (e.g., a storage) outside the application processor 1400, read and decode the encoded image signal from the memory 1430 or the external memory 1600, and display image data generated based on the decoded image signal. For example, the image processors 1411 and 1412 of the image processing device 1410 may perform decoding, and the image processor 1413 thereof may also perform image processing on decoded image signals.

In the second operation mode, the camera modules 1300a, 1300b, and 1300c may generate an image signal at a third speed lower than the first speed (e.g., generate an image signal at a third frame rate lower than the first frame rate) and transmit the image signal to the application processor 1400. The image signal provided to the application processor 1400 may be an unencoded signal. The application processor 1400 may perform image processing on the received image signal or store the image signal in the internal memory 1430 or the external memory 1600.

The PMIC 1500 may supply power, for example, a power supply voltage to each of the camera modules 1300a, 1300b, and 1300c. For example, under the control of the application processor 1400, the PMIC 1500 may supply first power to the camera module 1300a through a power signal line PSLa, second power to the camera module 1300b through a power signal line PSLb, and third power to the camera module 1300c through a power signal line PSLc.

In response to a power control signal PCON from the application processor 1400, the PMIC 1500 may generate power corresponding to each of the plurality of camera modules 1300a, 1300b, and 1300c, and may also adjust the level of power. The power control signal PCON may include a power adjustment signal for each operation mode of the plurality of camera modules 1300a, 1300b, and 1300c. For example, the operation mode may include a low power mode, and in this case, the power control signal PCON may include information on a camera module operating in a low power mode and information on a set power level. The levels of power provided to each of the camera modules 1300a, 1300b, and 1300c may be the same or different from each other. Also, the level of power may be dynamically changed.

The image sensor and the electronic device described above may include a pixel array having a rotating structure or a flip structure, to thereby acquire a disparity of an image generated by pixels for each color, generate depth information and a depth map, which are distance information between the image sensor and the subject, and perform an autofocus function based on the acquired disparity.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An image sensor comprising:
a sensor substrate having a plurality of unit patterns, wherein each unit pattern from among the plurality of unit patterns comprises a plurality of unit pixels, and wherein the plurality of unit pixels comprises a first unit pixel, a second unit pixel, a third unit pixel, and a fourth unit pixel;
a color separation lens array above the sensor substrate, and comprising a plurality of nanoposts, wherein the plurality of nanoposts are configured to separate incident light according to a wavelength within each unit pixel, and condense the separated light onto a corresponding pixel; and
an optical diffuser on the color separation lens array,
wherein each unit pixel from among the plurality of unit pixels comprises at least one first pixel configured to sense light having a first wavelength, at least one second pixel configured to sense light having a second wavelength, and at least one third pixel and at least one fourth pixel configured to sense light having a third wavelength,
wherein the first unit pixel is arranged according to a first structure, and
wherein the second unit pixel, the third unit pixel, and the fourth unit pixel are arranged according to at least one different structure which is rotated or flipped with respect to the first structure.

2. The image sensor of claim 1, wherein the image sensor is configured to perform an autofocus function using a plurality of images having different disparities which are acquired from first pixels at different positions within the plurality of unit pixels.

3. The image sensor of claim 1, wherein the plurality of unit pixels are arranged in 2×2 array in each unit pattern,
wherein the first unit pixel is included in a first row and a first column of each unit pattern, the second unit pixel is included in a second row and the first column of each unit pattern, the third unit pixel is included in the first row and a second column of each unit pattern, and the fourth unit pixel is included in the second row and the second column of each unit pattern.

4. The image sensor of claim 3, wherein the second unit pixel is arranged according to a second structure which is rotated by 90 degrees in a clockwise direction with respect to the first structure,
wherein the third unit pixel is arranged according to a third structure which is rotated by 270 degrees in the clockwise direction with respect to the first structure, and
wherein the fourth unit pixel is arranged according to a fourth structure which is rotated by 180 degrees with respect to the first structure.

5. The image sensor of claim 3, wherein the second unit pixel is arranged according to a second structure which is rotated by 90 degrees in a counterclockwise direction with respect to the first structure,
wherein the third unit pixel is arranged according to a third structure which is rotated by 270 degrees in the counterclockwise direction with respect to the first structure, and
wherein the fourth unit pixel is arranged according to a fourth structure that is rotated by 180 degrees with respect to the first structure.

6. The image sensor of claim 3, wherein the second unit pixel is arranged according to a second structure in which a first row and a second row are flipped with respect to the first structure,
wherein the third unit pixel is arranged according to a third structure in which a first column and a second column are flipped with respect to the first structure, and
wherein the fourth unit pixel is arranged according to a fourth structure which is flipped in a diagonal direction with respect to the first structure.

7. The image sensor of claim 1, wherein a width of each of the first to fourth pixels is in a range of 0.5 micrometers (μm) to 0.64 μm.

8. An electronic apparatus comprising:
a lens assembly comprising one or more lenses, wherein the lens assembly is configured to form an optical image of a subject;
an image sensor configured to convert the optical image into an electrical signal; and
a processor configured to process the electrical signal, wherein the image sensor comprises:
a sensor substrate having a plurality of unit patterns, wherein each unit pattern from among the plurality of unit patterns comprises a plurality of unit pixels, and wherein the plurality of unit pixels comprises a first unit pixel, a second unit pixel, a third unit pixel, and a fourth unit pixel;
a color separation lens array above the sensor substrate and comprising a plurality of nanoposts, wherein the plurality of nanoposts are configured to separate incident light according to a wavelength within each unit pixel and condense the separated light onto a corresponding pixel; and
an optical diffuser on the color separation lens array, and
wherein each unit pixel from among the plurality of unit pixels comprises at least one first pixel configured to sense light having a first wavelength, at least one second pixel configured to sense light having a second wavelength, and at least one third pixel and at least one fourth pixel configured to sense light having a third wavelength,
wherein the first unit pixel is arranged according to a first structure, and
wherein the second unit pixel, the third unit pixel, and the fourth unit pixel are arranged according to at least one different structure which is rotated or flipped with respect to the first structure.

9. The electronic apparatus of claim 8, wherein an autofocus function is performed using a plurality of images having different disparities which are acquired from first pixels at different positions within the plurality of unit pixels.

10. An autofocusing method comprising:
selecting an autofocus position;
acquiring an image of a selected area using a plurality of pixels at different positions within a plurality of unit pixels, wherein the plurality of unit pixels are included in a unit pattern and comprise a first unit pixel, a second unit pixel, a third unit pixel, and a fourth unit pixel;
measuring a disparity between a plurality of images of the selected area which are acquired from the plurality of pixels provided at the different positions;
determining a distance between a subject and an image sensor based on the disparity; and
adjusting a focus lens based on the distance,
wherein the first unit pixel is arranged according to a first structure, and
wherein the second unit pixel, the third unit pixel, and the fourth unit pixel are arranged according to at least one different structure which is rotated or flipped with respect to the first structure.

11. The autofocusing method of claim 10, wherein the measuring of the disparity between the plurality of images comprises:
acquiring a first image using a first pixel included in the first unit pixel;
acquiring a second image using a first pixel included in the second unit pixel; and
measuring a disparity between the first image and the second image.

12. The autofocusing method of claim 10, wherein the measuring of the disparity between the plurality of images comprises:
acquiring a first image using a first pixel included in the first unit pixel;
acquiring a second image using a first pixel included in the second unit pixel;
acquiring a third image using a first pixel included in the third unit pixel;
measuring a first disparity based on the first image and the second image; and
measuring a second disparity based on the first image and the third image.

13. The autofocusing method of claim 12, further comprising selecting one from among the first disparity and the second disparity by comparing the first disparity and the second disparity with a plurality of disparities included in a pre-stored table.

14. The autofocusing method of claim 10, wherein the second unit pixel is arranged according to a second structure which is rotated by 90 degrees in a clockwise direction with respect to the first structure,
wherein the third unit pixel is arranged according to a third structure which the first unit pixel is rotated by 270 degrees in the clockwise direction with respect to the first structure, and
wherein the fourth unit pixel is arranged according to a fourth structure which is rotated by 180 degrees with respect to the first structure.

15. The autofocusing method of claim 10, wherein the second unit pixel is arranged according to a second structure which is rotated by 90 degrees in a counterclockwise direction with respect to the first structure,
wherein the third unit pixel is arranged according to a third structure which is rotated by 270 degrees in the counterclockwise direction with respect to the first structure, and
wherein the fourth unit pixel is arranged according to a fourth structure which is rotated by 180 degrees with respect to the first structure.

16. The autofocusing method of claim 10, wherein the second unit pixel is arranged according to a second structure in which a first row and second row are flipped with respect to the first structure,
wherein the third unit pixel is arranged according to a third structure in which a first column and a second column are flipped with respect to the first structure, and
wherein the fourth unit pixel is arranged according to a fourth structure in which the first unit pixel is flipped based on a diagonal direction with respect to the first structure.

17. An image sensor comprising:
a sensor substrate comprising a plurality of unit pixels;
a color separation lens array above the sensor substrate, and comprising a plurality of nanoposts, wherein the plurality of nanoposts are configured to separate incident light according to a wavelength within each unit pixel of the plurality of unit pixels, and condense the separated light onto a corresponding pixel; and
an optical diffuser on the color separation lens array,
wherein each unit pixel from among the plurality of unit pixels comprises a plurality of pixels comprising a first pixel configured to sense light having a first wavelength, a second pixel configured to sense light having a second wavelength, and a third pixel a fourth pixel configured to sense light having a third wavelength, and
wherein the plurality of unit pixels comprises:
a first unit pixel in which the plurality of pixels are arranged according to first pattern, and
a plurality of other unit pixels in which the plurality of pixels are arranged in at least one other pattern that is rotated or flipped with respect to the first pattern.

18. The image sensor of claim 17, further comprising an image signal processor configured to perform an autofocus function using a plurality of images which are acquired from pixels corresponding to a same color at different positions within the plurality of unit pixels.

19. The image sensor of claim 18, wherein the image signal processor is further configured to perform the autofocus function by calculating disparities between the plurality of images.
